(19) United States
(12) Patent Application Publication
(10) Pub. No.: US 2009/0284851 A1
(43) Pub. Date: Nov. 19, 2009

(54) DEVICE AND METHOD FOR LOCKING LENS

(75) Inventors: Chih-Ming Huang, Hsinchu City (TW); Chih-Lun Chen, Hsinchu City (TW)

Correspondence Address: HAVERSTOCK & OWENS LLP, 162 N WOLFE ROAD, SUNNYVALE, CA, 94086, US

(73) Assignee: Mustek Technology Co., LTD, Hsinchu City (TW)

(21) Appl. No.: 12/353,750

(22) Filed: Jan. 14, 2009

(30) Foreign Application Priority Data
May 15, 2008 (TW) 097117910

(51) Int. Cl. G02B 7/02

(52) U.S. Cl. 359/823

(57) ABSTRACT

A device for locking lens and a method for the same are provided. The device is used in a voice-coil motor of a photographing module of a cell phone. The voice-coil motor has a lens-stand for a lens being turned to a locking depth inside. The device includes a circumgyration-stop instrument having a first sustaining surface, and a focusing ring having a turning end. A turn-locking length of the turning end is equal to the locking depth inside. The device includes a circumgyration-stop preventing a pressure being persisted to apply on the lens as the focusing ring finishes the turn of the lens. The first turn-stop surface props the first sustaining surface as the focusing ring is turned to an extremity of the turn-locking length. The focusing ring accordingly escapes the circumgyration-stop instrument for finishing the focusing of the lens in the lens-stand.

### FIELD OF THE INVENTION

The present invention relates to a device and a method for locking lens used in a voice-coil motor of a photographing module of a cell phone, and more particularly relates to a device and a method for locking lens with the locking length of the focusing ring equally to locking depth of the lens in the lens holder.

### BACKGROUND OF THE INVENTION

Nowadays the photo pixels of a photographic cell-phone are being promoted constantly, and the image quality of the photographing module therein is the most important, hence the image quality should be adjusted to an optimum condition when focusing a lens in the photographing module.

In general, the lens is configured in a lens holder of a Voice-Coil Motor (VCM), which relating to the technology of Micro-Electro Mechanical System (MEMS). Please refer to FIG. 1, which is a schematic diagram of the side section diagram of focusing a lens in a lens holder according to the prior art. As shown in FIG. 1, a lens holder 10 in a VCM is configured with four spring slices 11, a focusing ring 12 is used to locking a lens 13 into the lens holder 10 with a predetermined locking length. A circumgyration stopping instrument 14 is configured to fix the rotation of the lens holder 10 at first, then a lens 13 is put into the lens holder 10, the focusing ring 12 is put around the groove 15 of the lens 13, and then processing to rotate the lens 13 to lock the lens 13 into the lens holder 10.

Please refer to FIG. 2, which is a schematic diagram of the side section diagram of focusing a lens into a lens holder with a focusing position according to the prior art. As shown in FIG. 2, the focusing ring 12 is rotated to move the lens 13 in the lens holder 10 until the lens 13 in a position with a locking depth TD, while the lens 13 is in a predetermined focusing height FP. Since the lens 13 is pressed by the focusing ring 12 in the process, when the lens 13 reaches the position of the predetermined focusing height FP, the lens still bears a pressure from the focusing ring 12. The pressure (containing the weight of the focusing ring 12) produces elastic deformations in the lens 10 and the lens holder 10, especially when the lens 13 and the lens holder 10 are normally made by plastic materials.

Even though the lens 13 is adjusted to the right position for showing the image clearly, but when the focusing ring 12 is removed from the lens 13, the produced elastic deformations will disappear immediately, and the lens 13 and the lens holder 10 will be recovered to the normal condition without any pressure, and thus the position of the lens 13 will be changed and moved from the predetermined focusing height FP, so that the image will be out of focus and dim.

Therefore, it has a possibility to improve the focusing model that the lens 13 is kept under the pressure from the focusing ring 12.

From the above description, in order to overcome the drawbacks in the prior art, a device and a method for locking lens in a lens holder are provided by the inventor via the diligent research and perseverance working.

### SUMMARY OF THE INVENTION

In accordance with one aspect of the present invention, a lens locking device and method is provided to promote the focusing accuracy when focusing a lens in a lens holder, and preventing a focusing device applying a pressure onto the lens when the lens is fixed in the predetermined focusing height.

In accordance with another aspect of the present invention, a lens locking device is provided, the device comprising a lens, a lens holder, a focusing ring, and a circumgyration stopping unit, wherein the lens holder containing the lens and having a locking depth; the focusing ring fixing the lens to the lens holder and having a first stopping surface; and the circumgyration stopping unit having a first supporting surface urging against the first stopping surface while the focusing ring locks the lens to the locking depth.

Preferably, the first supporting surface receives a pressure exerted by the focusing ring when the first stopping surface urges against the first supporting surface for stopping the focusing ring.

Preferably, the lens reaches a focusing position when the first stopping surface urges against the first supporting surface, and afterward the focusing ring is detached from the circumgyration stopping unit.

Preferably, the focusing ring further has an acting end having a fixing length equals to the locking depth.

Preferably, the focusing ring further comprises a second stopping surface for urging against a second supporting surface of the circumgyration stopping unit.

Preferably, the circumgyration stopping unit further comprises at least a lateral translation preventing portion preventing a lateral translation of the focusing ring.

Preferably, the at least a lateral translation preventing portion has a bevel facilitating the focusing ring to be placed into the circumgyration stopping unit.

Preferably, the device is used with a voice-coil motor of a photographing module of a cell phone.

Preferably, the lens is a camera lens.

Preferably, the device further comprises a rotation positioning board positioning the circumgyration stopping unit.

In accordance with another aspect of the present invention, a locking apparatus is provided, the apparatus comprises a lens, a lens holder, a focusing device, and a stopping device, wherein the lens holder containing the lens and the focusing device fixing the lens into the lens holder and comprising an acting end, a first movement-stop surface, and a stopping device, wherein the stopping device has a first supporting surface urging against the movement-stop surface while the acting end is operated with a fixing length.

Preferably, the focusing device is a focusing ring.

Preferably, the first supporting surface receives a pressure exerted from the focusing ring when the first movement-stop surface urges against the first supporting surface for stopping the focusing ring, and then the focusing ring is detached from the stopping device.

Preferably, the fixing length is equal to a downwardly moved distance of the lens.

Preferably, the stopping device comprises a second supporting surface and the focusing ring further comprises a second movement-stop surface urging against the second supporting surface.

Preferably, the lens reaches a focusing position when the first movement-stop surface urges against the first supporting surface.

In accordance with another aspect of the present invention, a locking method for fixing a lens to a predetermined depth of a holder is provided, the locking method comprises steps of: depositing a stopping device upon the holder; pushing the lens into the holder by a focusing device; and stopping the lens at the predetermined depth by urging against the focusing device with the stopping device.

Preferably, the step of stopping the lens is by urging against a stopping surface of the focusing device with a supporting surface of the stopping device, and the lens is stopped at a focusing position.

Preferably, the focusing device is a focusing ring for pushing the lens into the holder by turning, and the stopping device is a circumgyration stopping device.

Preferably, the locking method further comprises a step of removing the focusing device from the stopping device, whereby there is no pressure applied on the lens.

The above objects and advantages of the present invention will become more readily apparently to those ordinarily skilled in the art after reviewing the following detailed descriptions and accompanying drawings, in which:

### BRIEF DESCRIPTION OF THE DRAWINGS

FIG. 1 is a schematic diagram of the side section diagram of focusing a lens in a lens holder according to the prior art;

FIG. 2 is a schematic diagram of the side section diagram of focusing a lens into a lens holder with a focusing position according to the prior art;

FIG. 3 is a schematic diagram of the top view of the device for locking lens of the present invention;

FIG. 4 is a schematic diagram of the device for locking lens combined with the circumgyration stopping instrument, rotational positioning board and the base of the present invention;

FIG. 5 is a schematic diagram of the side section of the focusing ring and the circumgyration stopping instrument of the present invention;

FIG. 6 is a schematic three-dimensional diagram of the focusing ring and the circumgyration stopping instrument of the present invention;

FIG. 7 is a schematic diagram of the A-A section of the device for locking lens shown in FIG. 3;

FIG. 8 is the schematic diagram of the top view of the focusing ring and the circumgyration stopping instrument of the present invention;

FIG. 9 is the parameters needed to be considered when determining the predetermined focusing height of the lens.

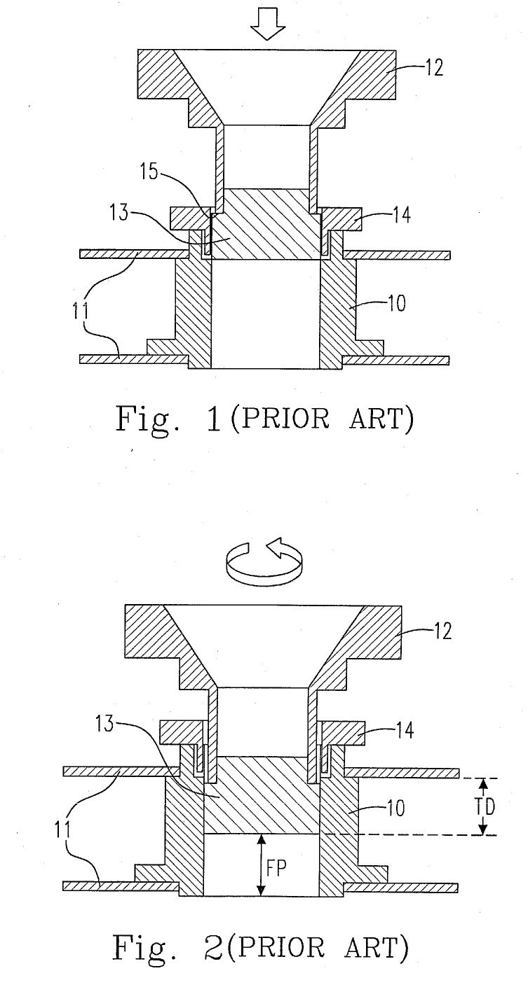

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

Please refer to FIG. 3, which is a schematic diagram of the top view of the device for locking lens of the present invention. As shown in FIG. 3, there is a locking lens device 30, which comprises a focusing ring 33 and circumgyration stopping instrument 32, wherein the focusing ring 33 covers on a lens (not shown) needed to be adjusted for focusing.

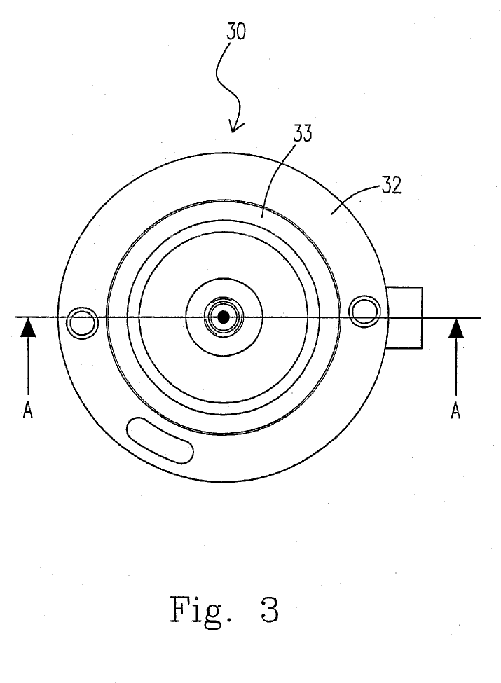

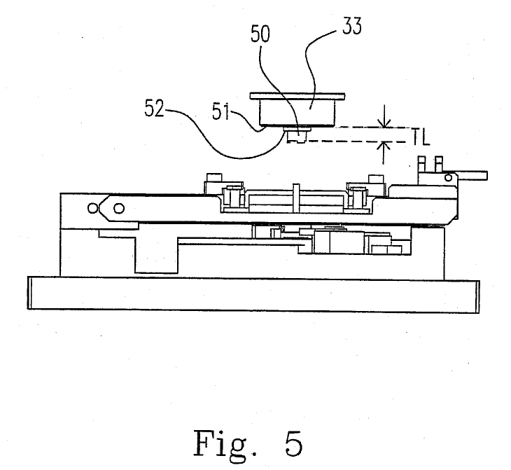

Please refer to FIG. 5, which is a schematic diagram of the side section of the focusing ring and the circumgyration stopping instrument of the present invention. As shown in FIG. 5, the focusing ring 33 is configured with an acting end 50 having a fixing length TL, wherein the fixing length TL is equal to the locking depth TD (shown in FIG. 2 of the prior art). The focusing ring 33 has a first stopping surface 51 and a second stopping surface 52, which is configured for preventing the focusing ring 33 from applying a pressure on the lens when the process of focusing the lens is finished.

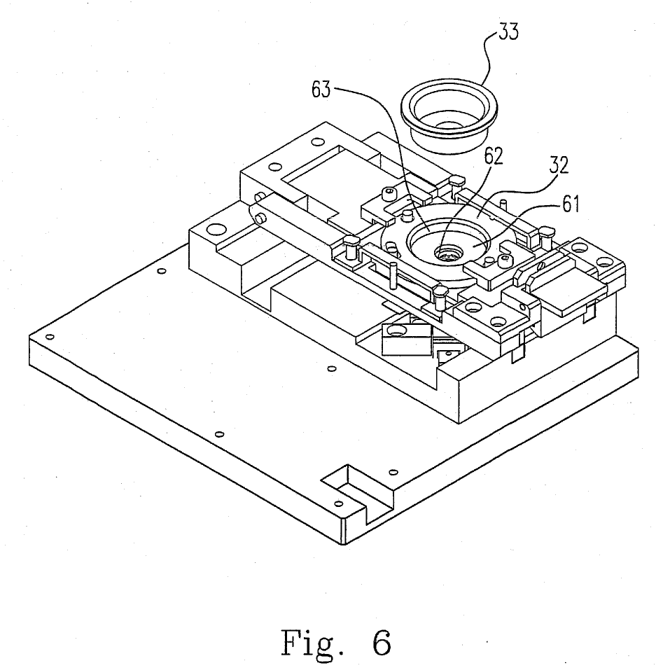

Please refer to FIG. 6, which is a schematic three-dimensional diagram of the focusing ring and the circumgyration stopping instrument of the present invention. As shown in FIG. 6, the circumgyration stopping instrument 32 is configured with a container 63. When the focus ring 33 is operated with a fixing length TL, the first stopping surface 51 and the second stopping surface 52 immediately touch the first support surface 61 and the second support surface 62 and are supported thereby, and afterward the focusing ring is removed from the lens (not shown) and the circumgyration stopping instrument 32. Since the focusing ring 32 does not apply any pressures on the lens when leaving therefrom, no extra deformation is produced thereafter, and the locking depth TD (shown in FIG. 2 of the prior art) will not be changed and the accurate focusing for the lens module is obtained.

Furthermore, when the first stopping surface 51 touches and is supported by the first support surface 61, the pressures applied from the focusing ring 33 is switched from the lens 13 to the first support surface 61 of the circumgyration stopping instrument 32, and the lens 13 is settled in the right position, which is the position of the predetermined focusing height FP as shown in FIG. 2.

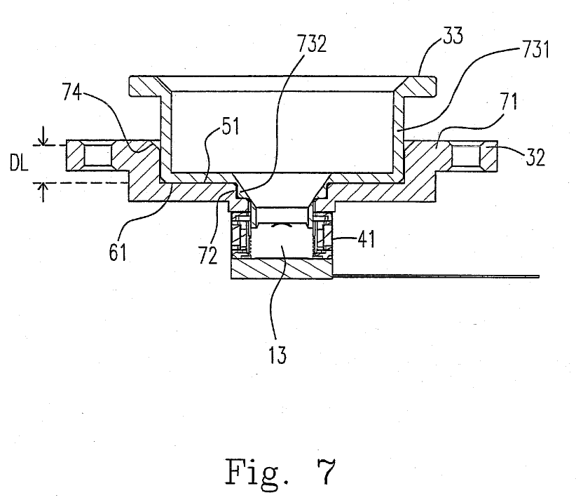

Please refer to FIG. 7, which is a schematic diagram of the A-A section of the device for locking lens shown in FIG. 3. As shown in FIG. 7, there is a first support surface 61 on the circumgyration stopping instrument 32, which is configured to support the first stopping surface 51 of the focusing ring 33. The circumgyration stopping instrument 32 also has a first lateral translation preventing portion 71 and a second lateral translation preventing portion 72, which is configured to prevent the lateral translations of the first side 731 and the second side 732 of the focusing ring 33. Preferably, the first lateral translation preventing portion 71 could be configured with a bevel 74 facilitating the focusing ring 33 to be placed into the container 63 of the circumgyration stopping instrument 32.

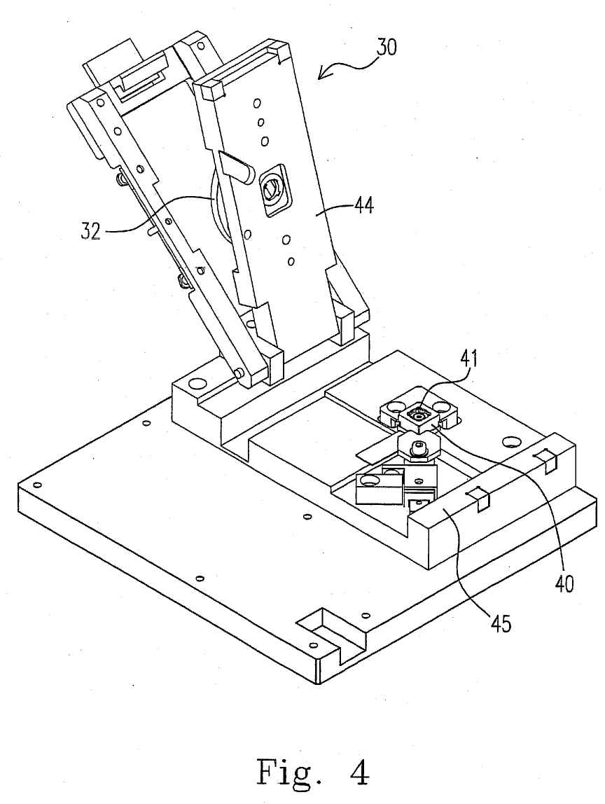

Please refer to FIG. 4, which is a schematic diagram of the device for locking lens combined with the circumgyration stopping instrument, rotational positioning board and the base of the present invention. As shown in FIG. 4, a locking device 30 is used for fabricating the voice-coil motor 40 of a photographing module of a cell phone. The voice-coil motor 40 has a lens holder 41, which is configured for a lens to be fixed in. The locking device 30 has a rotation position board 44 and a base 45, wherein the rotation position board 44 is rotatably connected with the base 45, so as to accurately locate and put the circumgyration stopping instrument 32 onto the lens holder 41 placed in the base 45.

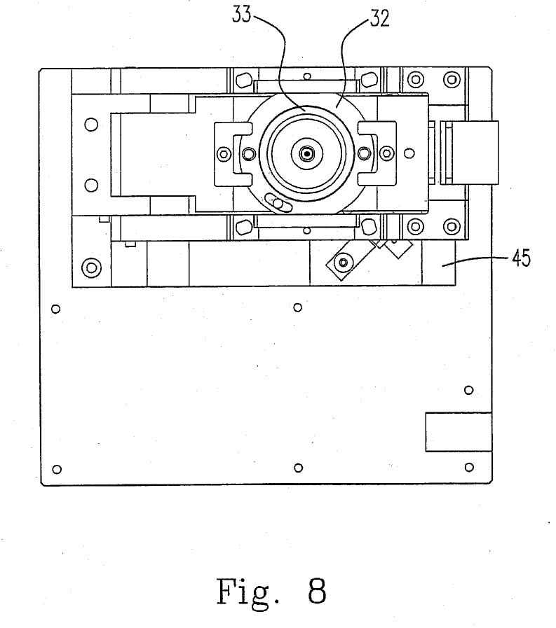

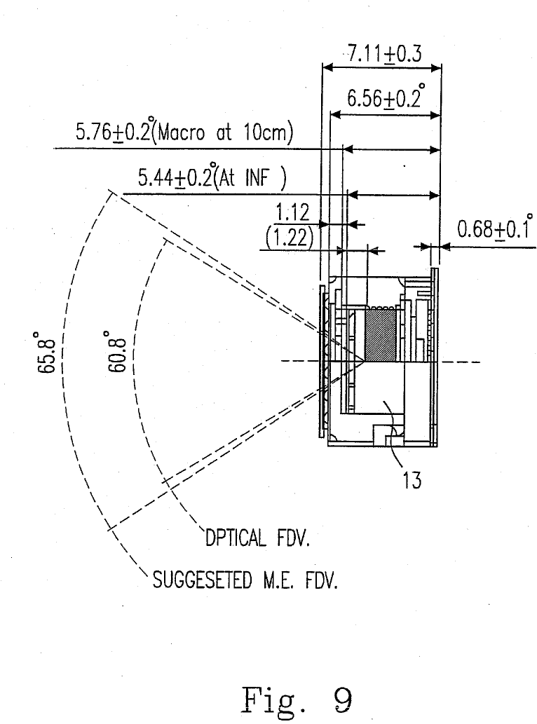

Please refer to FIG. 8, which is the schematic diagram of the top view of the focusing ring and the circumgyration stopping instrument of the present invention. As shown in FIG. 8, the circumgyration stopping instrument 32 and the focusing ring 33 is accurately located and put onto the base 45. Furthermore, what is shown in FIG. 9 are the parameters needed to be considered when determining the predetermined focusing height FP of the lens 13.

One of the main characteristics of the invention is a locking device 30 locking lens 13 used with a voice-coil motor 40 of a photographing module of a cell phone, wherein the voice-coil motor has a lens 13 and a lens holder 41 for containing the lens 13, which is fixed with a locking depth TD thereinside. The locking device 30 contains a focusing unit, i.e. focusing ring 33, and a circumgyration stopping instrument 32. The circumgyration stopping instrument 32 has at least a supporting surface 61 or 62, and the focusing ring 33 has a acting end 50 and at least a stopping surface 51 or 52, wherein the acting end 50 is configured with a fixing length TL equal to the locking depth TD, and the at least a supporting surface 61 or 62 urge against the at least a stopping surface 51 or 52 while the focusing ring 33 locks the lens 13 to the locking depth TD, at the same time, the at least a supporting surface 61 or 62 receives pressures exerted by the focusing ring 33, and there is no extra pressure applied on the lens from the focusing ring 33, and afterward the focusing ring 33 is detached from the circumgyration stopping instrument 32. Besides, the circumgyration stopping instrument 32 is not essential in the invention, and one skilled in the art can easily practice the embodiment disclosed as above without a circumgyration stopping instrument.

Another one of the main characteristics of the invention is a locking method for fixing a lens 13 to a predetermined depth TD of a holder 41 and preventing the image via the lens 13 from becoming out of focus and dim. The method comprising steps of mounting a circumgyration stopping device 32 upon the lens holder 41; pushing the lens 13 (i.e. by rotation) into the lens holder 41 by a focusing device 33; stopping the lens 13 at the predetermined depth TD by urging against the at least a stopping surface 51, 52 of focusing device 33 with the at least a supporting surface 61, 62 of the circumgyration stopping device 32; and then detaching the focusing device from the stopping device, so that there is no pressure applied on the lens.

Furthermore, since the fixing length TL of the acting end 50 is set equal to the locking depth TD, the first supporting surface 61 (or the second supporting surface 62) touched and urges against the first stopping surface 51 (or the second stopping surface 52), and the distance the first stopping surface 51 moves down above the first supporting surface 61 of the circumgyration stopping device 32.

Consequently, the defect of the lens going out of focus in the process of assembling the photographing module is indeed solved by the means mentioned above of the present invention, and the defect of that there is an extra pressure applied in the lens by the focusing ring when the lens is moved to the predetermined position of the focusing height is also overcome. Furthermore, at least one stopping surface is added to cooperate with the first stopping surface.

In sum, the efficacy and the progression of the focusing device and method of present invention are surely obtained, while the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A lens locking device, comprising:
a lens;
a lens holder containing the lens and having a locking depth;
a focusing ring fixing the lens to the lens holder and having a first stopping surface; and
a circumgyration stopping unit having a first supporting surface urging against the first stopping surface while the focusing ring locks the lens to the locking depth.

2. The device according to claim 1, wherein the first supporting surface receives a pressure exerted by the focusing ring when the first stopping surface urges against the first supporting surface for stopping the rotation of the lens.

3. The device according to claim 1, wherein the lens reaches a focusing position when the first stopping surface urges against the first supporting surface, and afterward the focusing ring is detached from the circumgyration stopping unit.

4. The device according to claim 1, wherein the focusing ring further has an acting end having a fixing length equals to the locking depth.

5. The device according to claim 1, wherein the focusing ring further comprises a second stopping surface for urging against a second supporting surface of the circumgyration stopping unit.

6. The device according to claim 1, wherein the circumgyration stopping unit further comprises at least a lateral translation preventing portion preventing a lateral translation of the focusing ring.

7. The device according to claim 6, wherein the at least a lateral translation preventing portion has a bevel facilitating the focusing ring to be placed into the circumgyration stopping unit.

8. The device according to claim 1 being used with a voice-coil motor of a photographing module of a cell phone.

9. The device according to claim 1, wherein the lens is a camera lens.

10. The device according to claim 1 further comprising a rotation positioning board positioning the circumgyration stopping unit.

11. A locking apparatus, comprises:
a lens;
a lens holder containing the lens; and
a focusing device fixing the lens into the lens holder and comprising:
an acting end; and
a first movement-stop surface; and
a stopping device having a first supporting surface urging against the movement-stop surface while the acting end is operated with a fixing length.

12. The locking apparatus according to claim 11, wherein the focusing device is a focusing ring.

13. The locking apparatus according to claim 12, wherein the first supporting surface receives a pressure exerted from the focusing ring when the first movement-stop surface urges against the first supporting surface for stopping the rotation of the lens, and then the focusing ring is detached from the stopping device.

14. The locking apparatus according to claim 12, wherein the fixing length is equal to a downwardly moved distance of the lens.

15. The locking apparatus according to claim 12, wherein the stopping device comprises a second supporting surface and the focusing ring further comprises a second movement-stop surface urging against the second supporting surface.

16. The locking apparatus according to claim 11, wherein the lens reaches a focusing position when the first movement-stop surface urges against the first supporting surface.

17. A locking method for fixing a lens to a predetermined depth of a holder, comprising steps of:
depositing a stopping device upon the holder;
pushing the lens into the holder by a focusing device; and
stopping the lens at the predetermined depth by urging against the focusing device with the stopping device.

18. A locking method according to claim 17, wherein the step of stopping the lens is by urging against a stopping surface of the focusing device with a supporting surface of the stopping device, and the lens is stopped at a focusing position.

19. A locking method according to claim 17, wherein the focusing device is a focusing ring for pushing the lens into the holder by turning, and the stopping device is a circumgyration stopping device.

20. A locking method according to claim 17 further comprises a step of removing the focusing device from the stopping device, whereby there is no pressure applied on the lens.
